(19) United States
(12) Patent Application Publication
(10) Pub. No.: US 2013/0159940 A1
(43) Pub. Date: Jun. 20, 2013

(54) Gesture-Controlled Interactive Information Board

(71) Applicants: Mikel Duffy, Santa Clara, CA (US); Taiheng (Matthew) Jin, Santa Clara, CA (US); May Huang, San Jose, CA (US); Barbara Jill Hecker, Campbell, CA (US)

(72) Inventors: Mikel Duffy, Santa Clara, CA (US); Taiheng (Matthew) Jin, Santa Clara, CA (US); May Huang, San Jose, CA (US); Barbara Jill Hecker, Campbell, CA (US)

(73) Assignee: International Technological University, San Jose, CA (US)

(21) Appl. No.: 13/589,387

(22) Filed: Aug. 20, 2012

Related U.S. Application Data
(60) Provisional application No. 61/526,220, filed on Aug. 22, 2011.

(51) Int. Cl. G06F 3/01

(52) U.S. Cl. CPC G06F 3/017
USPC 715/863

(57) ABSTRACT

A method of controlling an information board comprises the steps of sensing a gesture using a gesture capturing controller, determining a type of action having provided the gesture expression from the gesture capturing controller, where the type of command is one of a navigation request. Depending on the determined type of gesture, user interface elements of a spatial configuration are displayed.

### FIELD OF THE INVENTION

The present invention relates to a method of controlling an information board using human initiated gestures, a gesture capturing device and a computer program performing such a method. Specifically, the invention relates to facilitating user input using a gesture recognition system.

### BACKGROUND

An information board is a form of communication used to present various content items to the user. Content would include any form of data that can be interfaced with human sensory perception. The present invention relates to an information board of the type comprising of a display that accepts input from a gesture-capturing device. The information board may be used to browse websites, news, print documents, draw shapes, or play music or perform whatever functionality is made available to the user. The input device, an RGBD or image segmentation aware type of camera, captures human gestures and then the software running on the system translates the human generated intentions, hand and body or motion gestures into some meaningful operation or control in real time, to be used as a means of navigation for the information board. These gesture-based controls create an interactive user interface where the user can navigate, select and operate various features included on the information board.

Navigation and selection features include the selection of content, sending and receiving messages, asking questions and the use of all other information board features. The use of human gestures to navigate the information board eliminates the need for users to use control devices such as a touch screen, keyboard, mouse, remote control or other physical control devices. Instead of using markers, keyboards and/or mouse pointer controls, this new interactive information board dramatically improves the user's experience and makes the navigation and discover of information easier to access and control.

### SUMMARY OF THE INVENTION

An objective of the invention is to overcome at least some of the drawbacks relating to touch and other types of human interactive controlled information board designs. Known information boards suffer from the disadvantage of being difficult to navigate and understand and require human contact with a physical device to navigate. This may contribute to the exchange of bacteria, viruses, and dirt when used in a public environment where information boards are normally displayed. Known information boards also delivery unchanging information to eliminate the need to provide a remote or other control device that can be stolen, lost or damaged.

Other traditional style interactive information and “white boards” use digital pens as input devices that use digital ink to replace traditional “white board” markers. Digital pens are often lost or broken and can be difficult to use. In these types of devices projectors are often used to display a computer's video output on the white board interface, which acts as a large touch screen. Proper lighting is needed as well as a touchable surface. Interactive white boards also typically require users to train the software prior to the use of any interactive functionality. The proposed interactive information board does not suffer from any of these requirements as no special surface, lighting or digital pen or touch related equipment is needed.

It is the principal object of the present invention to obtain a type of interactive information board that can be interactive with the user in a safe and understandable way without exposing the user to potentially harmful elements. The present invention can be used in such places as hospitals, nurseries, day-care centers, bus and airport terminals, schools and any public place where there is a high a volume of public use and where traditional physically controlled devices requiring human contact might become contaminated, dirty, broken or lost.

### BRIEF DESCRIPTION OF THE DRAWINGS

Having thus described the invention in general terms, reference will now be made to the accompanying drawings, which are not necessarily drawn to scale, and wherein:

FIG. 1 illustrates the application implementation level design of the interactive gesture controlled information board.

FIG. 2 illustrates the partition of device's working area.

FIG. 3 illustrates the design of the content layer that includes “Root Page Layer” (Layer 1) and “Sub Page Layer” (Layer 2).

FIG. 4 illustrates the standard layout design.

FIG. 5 illustrates how to grab a form and print it out using an open/close palm gesture with the interactive information board.

### DETAILED DESCRIPTION

The system provides a gesture based interface used to navigate and control the display of information and content on an information board that is displayed on a screen. The operator of the system navigates and manipulates the elements of the information board by issuing gestural commands using the operator's hands, arms and other body elements. The user's head, feet, arms, legs, or entire body may be used to provide the navigation and control. A system of cameras can detect the position, orientation and movement of the user's hands and body elements and translates that information into executable commands to be used to navigate and operate the information board.

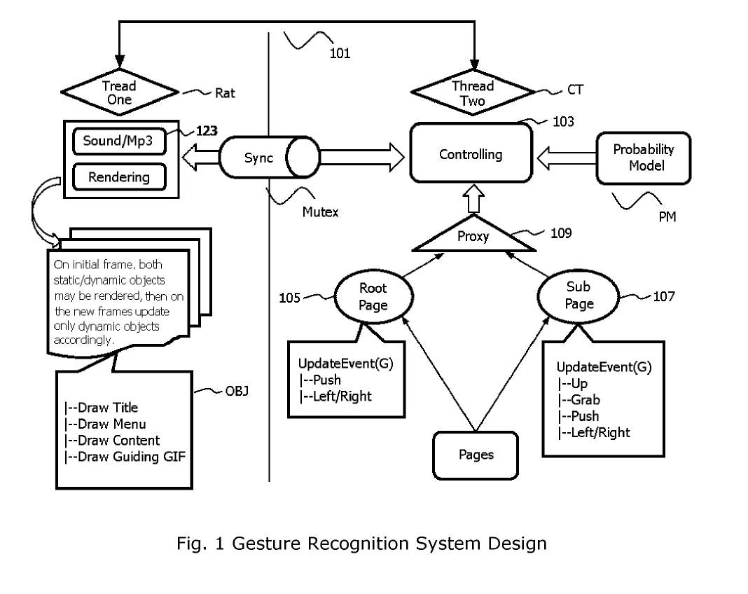

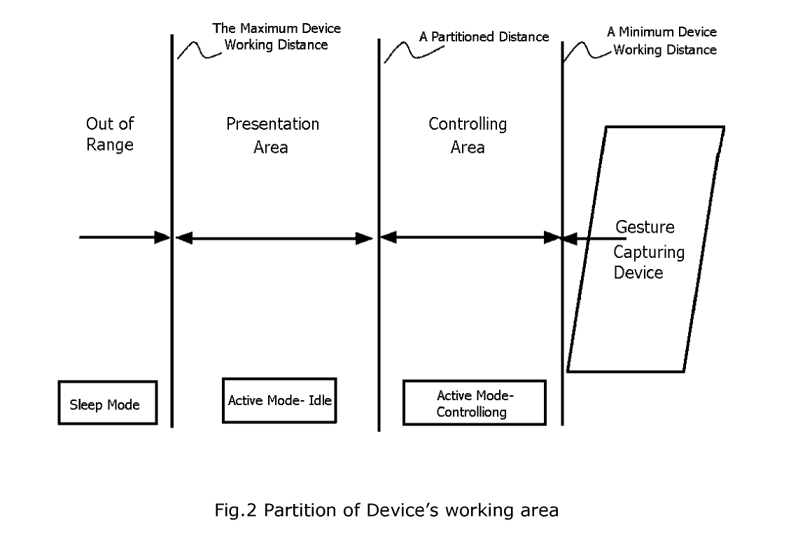

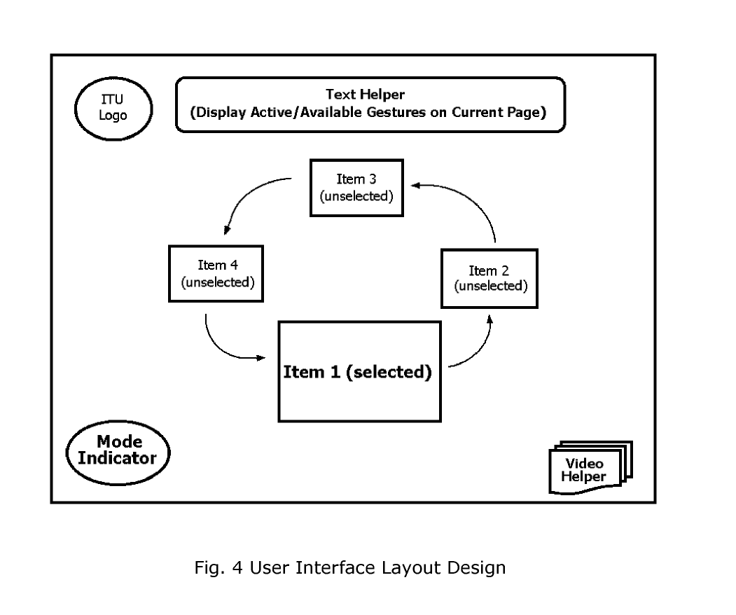

FIG. 1 illustrates the application implementation level design of the interactive information board. First, in step 101, the system will generate two threads that run simultaneously which are labeled, “Rendering/Audio Thread(RAT)” and “Controlling Thread (CT)”. During this application initial phase, all the resources including “Reference Gestures”, “Dynamic Objects”, “Static Objects”, “Images”, and “Audio” (details see FIG. 2) are also loaded into memory. Next in step 103, upon the end of initial phase, the application will be in “Sleeping Mode”. A gesture capturing device (GCD) is used to identify a new user, capture a hand or body movement, and send the status of whether a new user successfully detected back to the CT at a relatively high frequency, as well as the 3D position of his hand if a new user's successfully detected. After a new user is identified, the application will try to collect a new set of hand/body points from the GCD and save them into a queue, by analyzing the trace of the movements, the system may determine whether they are equal to reference gesture (e.g. a “Push” gesture) characteristics which activate the “active mode” so that the user starts to interact with application with consequent meaningful gestures. As soon as CT obtained a new page index, RAT will render objects accordingly (Label OBJ); this could be performed by synchronization between two threads (Labeled Mutex). During the whole “active Mode”, RAT will maintain several dynamic objects for each frame, e.g., “Text Helper”, “Video Helper”, “Mode Indicator” dynamic objects are determined by mainly two factors. The current page index and a guessed gesture estimated by Probability Model (Labeled PM), the probability model takes recent few user's hand traces as input, compare them to the “Available Gestures” on the current page, computes the similarity to each gesture and returns the most similar one, which determines the new updates to the dynamic objects. These helpers are used to guide new users who are unfamiliar to the gesture controls. Next, in step 105 and 107, CT may encrypt the meaningful gestures made by user, then calculate the index of new page and sync it with RAT through the Mutex. Once a new Page index is received, RAT will then update the frame onto the display and optionally play a sound effect (Labeled 123). Generally on Sub Pages (Labeled 107), CT supports more reference gestures for specific application purposes, e.g., form printing (see FIG. 4), Mp3 Player. During the “active mode”, a user may switch between its two sub-modes, “Idle mode” and “Controlling Mode”, the difference between them is that, while the application remains in “active mode”, whether CT should analyze and encrypt the consequent user gesture and this is handled by the Proxy (Labeled 109). Based on the hand distance to the gesture capturing device (FIG. 2) the Proxy may determine the current mode and indicates it through Mode Indicator, e.g. when the hand goes closer than the minimum device working distance, Proxy will prompt a box to the screen and tells user to move his hand away from display; Similarly when the hand goes out of the maximum device working distance, Proxy will prompt a 10 sec counting box to the screen indicates the time left till the current session automatically ends; when the hand goes from controlling area to presentation area, Proxy will ignores further user gestures and until user move his hand back in controlling area again.

FIG. 2 illustrates the partition of device's working area. Every gesture capturing device has its own working area which lies in between of the device's maximum and minimum working distance. As shown in FIG. 2, the working zone gets split in half by a “pivot”, which can be implemented by setting a partitioned distance. The first half of partitioned zone is so called presentation area, once the detected hand moves into this area, information board would remain on the most recent page, and the subsequent gestures will also be ignored until the hand gets back to the other half of partitioned zone, the Controlling Area.

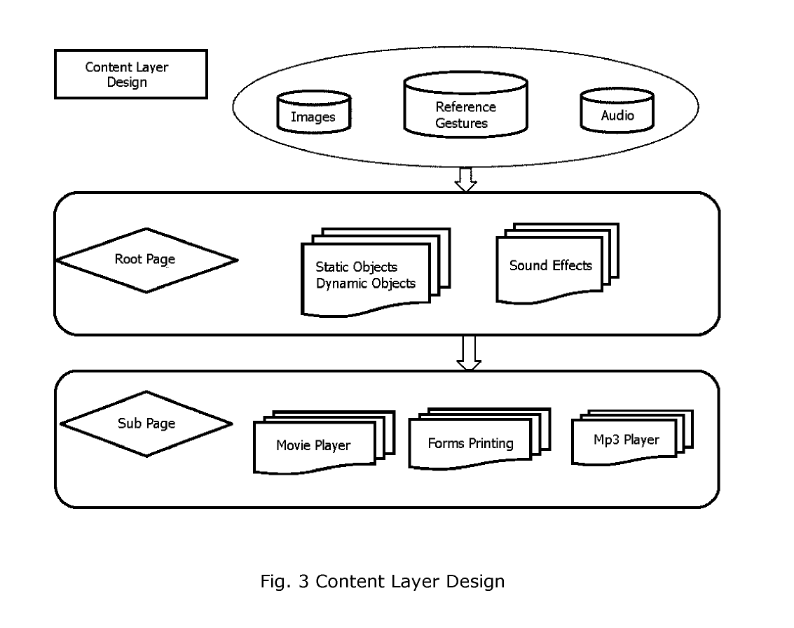

FIG. 3 illustrates the design of the content layer that includes “Root Page Layer” (Layer 1) and “Sub Page Layer” (Layer 2). The Layer 0 which consists of “Images”, “Audio” and “Reference Gestures” needs to be loaded at the initialization step of the interactive information board. Layer 1 generates Static Objects, Dynamic Objects and Sound Effects, some of these fundamental components that are also needed for Layer2, thus Layer 2 may inherit unchanged contents from lower Layers, but as a higher layer, Layer2 certainly consumes more resources to build up and support more complex modules, e.g., Movie Player, Mp3 Player, Form Printing.

FIG. 4 illustrates the standard layout design. On the screen, besides an ITU logo, three items are always displayed for assisting users in controlling the interactive information board. One of the items is an icon shown at the bottom-left corner of the screen that indicates the current mode. The current mode may be one of “sleeping mode”, “active mode-idle”, “active mode-controlling”. Another item is the Text Helper at the top-center of the screen it displays the available gestures on the current page in BLACK, and will highlight the new captured user gesture in GREEN. The other item is the Video Helper shown at the bottom-right corner of the screen. It demonstrates the user how to draw his desired gesture (guessed by PM, see FIG. 1) or how to correct a wrong gesture. Depends on the content layer level, there may have a menu consists of “selected item”, “unselected item” or a virtual module displayed onto the screen.

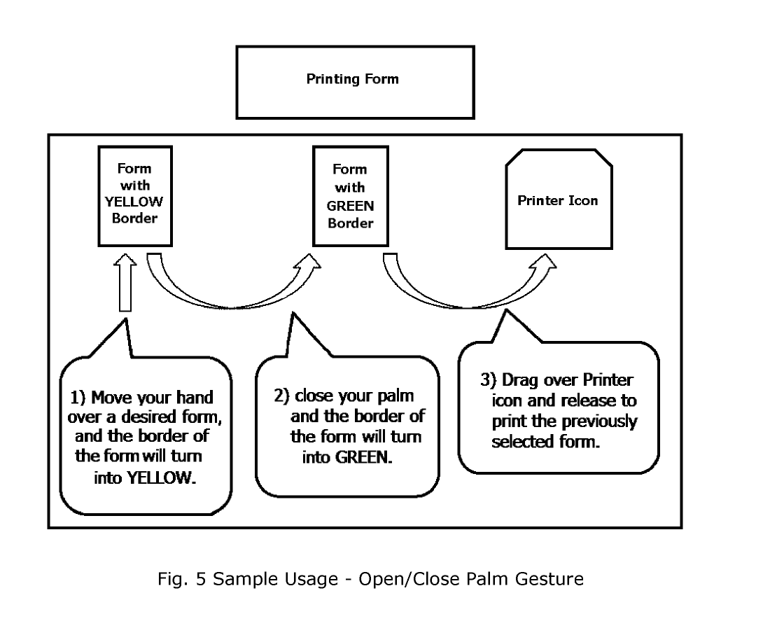

FIG. 5 illustrates how to grab a form and print it out using an open/close palm gesture with the interactive information board. More potential functionality may include playing a virtual DJ mixer, music, drawing or displaying photos or images and navigating various content items.

### Operation and Sample Usage

The following is a description of one cycle of a standard session with the interactive information board:

1.) The interactive information board starts out by default in “sleep mode,” and there is a lock icon displayed at the bottom-left corner of the main window along with Text/Video helpers to help guide users to trigger a push gesture to start the system.

2.) To enter into controlling mode or start a new controlling session, the user may simply push towards to the big display (TV/projector or Monitor screen), the hand distance should be within device range. The user may also use the HELP guide for a reference to become more familiar with the interactive information board usage features.

3.) Once a push gesture is detected, the application will be unlocked and jump into the “Menu Page.” The detected hand or body movement (a red point) will also be displayed on the screen. Mode indicator will guides the user the current type of active mode. If a user's willing to interact with information board but his hand's not currently within partitioned distance (see FIG. 2), then he need to move his hand towards to display until the mode indicator turns to “active-mode-controlling”, vice versa.

4.) On the “Root Page,” there will be a few 3D-like selectable object icons that will be positioned in a circle, one icon in bigger size which indicates it is currently selected, and the other icons will be of a smaller size which means they are not currently selected. To switch icons on the menu, the user may trigger a left or right gesture, after the desired icon is selected, to view the contents under the selected icon, the user may trigger a push gesture, the main menu will then disappear and the corresponding contents will be displayed. During the entire process the user may rely on the Text/Video Helpers for guidance.

5.) Some sample functions that are provided in the contents include: “Left/Right gesture” for switching slides, “Grab gesture” for printing forms and “Up gesture” for going back main menu.

6.) To exit from active mode into sleeping mode, the user simply walks away from the device working range.

7.) The entire process is repeated once a user is detected again.

1. A method of controlling an information board comprising a visual information display, the method comprising the steps of: sensing a human body gesture given to the gesture controller for the visual information display, determining a type of implement having provided the sensed activation of a control or interaction on the gesture sensitive display, said type of implement being one of at least a command type and a navigation type, and depending on the determined type of implement, displaying user interface elements of a first spatial configuration when the determined type of implement is the command type and displaying user interface elements of a second spatial configuration when the determined type of implement is the navigation type.

2. The method according to claim 1, wherein the human initiated gesture corresponds to a human hand or body part movement.

3. The method according to claim 1, wherein the human initiated gesture corresponds to a body part position and movement characteristics.

4. The method according to claim 1, wherein the step of sensing a gesture is based on the body part distance to the gesture capturing device.

5. The method according to claim 1, wherein the step of sensing a gesture involves providing selection information in the form of measuring the body part gesture speed information.

6. An information board display terminal comprising a digital display and: gesture sensing means for sensing an activation of a control or interaction on the gesture sensitive display, determining means for determining a type of implement having provided the sensed activation of a control or interaction on the gesture sensitive display, said type of implement being one of at least a command type and a navigation type and control means configured for, depending on the determined type of implement, displaying user interface elements of a first spatial configuration when the determined type of implement is the command type and displaying user interface elements of a second spatial configuration when the determined type of implement is the navigation type.

7. The terminal according to claim 6, wherein the first and second spatial configurations correspond to a respective first and second spatial distribution of user interface elements.

8. The terminal according to claim 6, wherein the step of sensing a gesture is based on the body part distance to the gesture capturing device.

9. The terminal according to claim 6, wherein the step of sensing a gesture involves providing selection information in the form of measuring the body part movement speed information.

10. The terminal according to claim 6, wherein the gesture capture sensing means comprises means for providing activation of a control or interaction on information comprising information regarding spatial distribution of the gesture controlled information.

11. A computer program product comprising a computer readable medium having computer readable software instructions embodied therein, wherein the computer readable software instructions comprise: computer readable software instructions capable of sensing a gesture activation of a control or interaction on the gesture sensitive display, computer readable software instructions capable of determining a type of implement having provided the sensed activation of a control or interaction on the sensitive display, said type of implement being one of at least a command type and a navigation type, and computer readable software instructions capable of, depending on the determined type of implement, displaying user interface elements of a first spatial configuration when the determined type of implement is the command type and displaying user interface elements of a second spatial configuration when the determined type of implement is the navigation type.

12. The computer program product according to claim 11, wherein the computer readable software instructions that are capable of sensing a gesture are further capable of providing gesture information in the form of at least one of distance from device information, body part movement speed information and spatial distribution of gesture initiated activation of a control or interaction on the information display.
